(19) United States
(12) Patent Application Publication
(10) Pub. No.: US 2010/0166121 A1
(43) Pub. Date: Jul. 1, 2010

(54) METHODS AND APPARATUS FOR RECEIVER HAVING FAST WALSH TRANSFORM

(75) Inventor: Lawrence M. Kenney, JR., Lutherville, MD (US)

Correspondence Address: RAYTHEON COMPANY;C/O DALY, CROWLEY, MOFFORD & DURKEE, LLP, 354A TURNPIKE STREET, SUITE 301A, CANTON, MA, 02021, US

(73) Assignee: Raytheon Company, Waltham, MA (US)

(21) Appl. No.: 12/600,729

(22) PCT Filed: Jun. 19, 2008
(86) PCT No.: PCT/US08/67475

§ 371 Date: Nov. 18, 2009

Related U.S. Application Data
(60) Provisional application No. 60/944,805, filed on Jun. 19, 2007.

(51) Int. Cl. H04L 27/06

(52) U.S. Cl. 375/343

(57) ABSTRACT

Methods and apparatus for correlating a receiving signal using a Fast Walsh Transform for efficient processing. In one embodiment, a Walsh encoded signal is received and then processing using a Fast Walsh Transform to generate outputs from which a largest one of the orthogonal sequences is selected.

### STATEMENT REGARDING FEDERALLY SPONSORED RESEARCH

The Government may have certain rights in this application pursuant to Contact No. W15P7T-04-C-K402.

### BACKGROUND

As is known in the art, signals can be encoded prior to transmission and decoded after reception. There are a wide variety of coding schemes used in many communication applications. One such technique is known as the Walsh Transform. Data is encoded using a Walsh sequence and processed using a Walsh Function correlator.

FIG. 1 shows a conventional receiver 10 having direct correlation processing. In phase (I) and Quadrature (Q) data are processed by a de-rotation module 12. Data is sent to an I correlator module 14 having Walsh Function correlators, where the number of Walsh Function correlators corresponds to the encoding scheme. For example, where 4 information bits are encoded with a 16-chip Walsh sequence, 16 chip symbols are generated. The outputs from each of the 16 Walsh Function correlators are provided to a magnitude module, such as a root-sum-square approximation module 16, having an output for each Walsh Function. Similar processing is provided by a Q correlator module 18. A maximum selector module 20 selects the sequence having the maximum magnitude, i.e., the transmitted Walsh sequence.

For example, where 4 bits are encoded with a 16-chip Walsh sequence before transmission, in order to recover the encoded 4 information bits the receiver must determine which of the 16 orthogonal sequences was transmitted, as shown in FIG. 2. In this arrangement, sixteen individual correlators are required in the receiver processor. Where N=16 bits, N² (256) operations are required.

In conventional processing schemes that use 16 parallel correlators to decode the Walsh encoded data in the waveform, to realize practical receiver implementations a limiting receiver is used for the input data to reduce the dynamic range of the input samples to as few as four bits per chip to minimize the complexity of the correlator logic circuits. This balances the hardware resources required with a significant trade-off in system performance in adverse environments.

### SUMMARY

The present invention provides methods and apparatus for providing efficient processing of Walsh encoded data using Fast Walsh Transforms. With this arrangement, the processing is significantly more efficient as compared with direct correlator configurations. While exemplary embodiments of the invention are shown and described in particular configurations and data widths, it is understood that the invention is applicable to data processing in general in which efficient processing of Walsh encoded data is desirable.

In one aspect of the invention, a method comprises receiving a complex valued Walsh encoded signal in the in-phase and quadrature channels of a linear receiver processor, performing Fast Walsh Transform processing to generate estimates of a cross correlation of the received Walsh encoded signal with Walsh sequences separately in the in-phase and quadrature channels, combining the estimates of the in-phase and quadrature channel data using a magnitude approximation, selecting a first one of the data words from the combined estimates having a largest magnitude, decoding the encoded signal using the selected first one of the data words, and outputting the decoded signal.

In another aspect of the invention, a system comprises a receiver to receive a Walsh encoded input signal, an in-phase Fast Walsh Transform module to generate in-phase data words by performing Fast Walsh Transform processing for generating estimates of cross correlation of the received Walsh encoded input signal with Walsh sequences, a quadrature Fast Walsh Transform module to generate quadrature data words by performing Fast Walsh Transform processing for generating estimates of cross correlation of the received Walsh encoded input signal with Walsh sequences, a magnitude module to combine the respective in-phase data words from the in-phase module and the quadrature data words from the quadrature module for providing magnitude information for the data words, and a selection module to select a first one of the combined in-phase and quadrature data words having a greatest magnitude.

### BRIEF DESCRIPTION OF THE DRAWINGS

The foregoing features of this invention, as well as the invention itself, may be more fully understood from the following description of the drawings in which:

FIG. 1 is a prior art receiver having direct correlation;

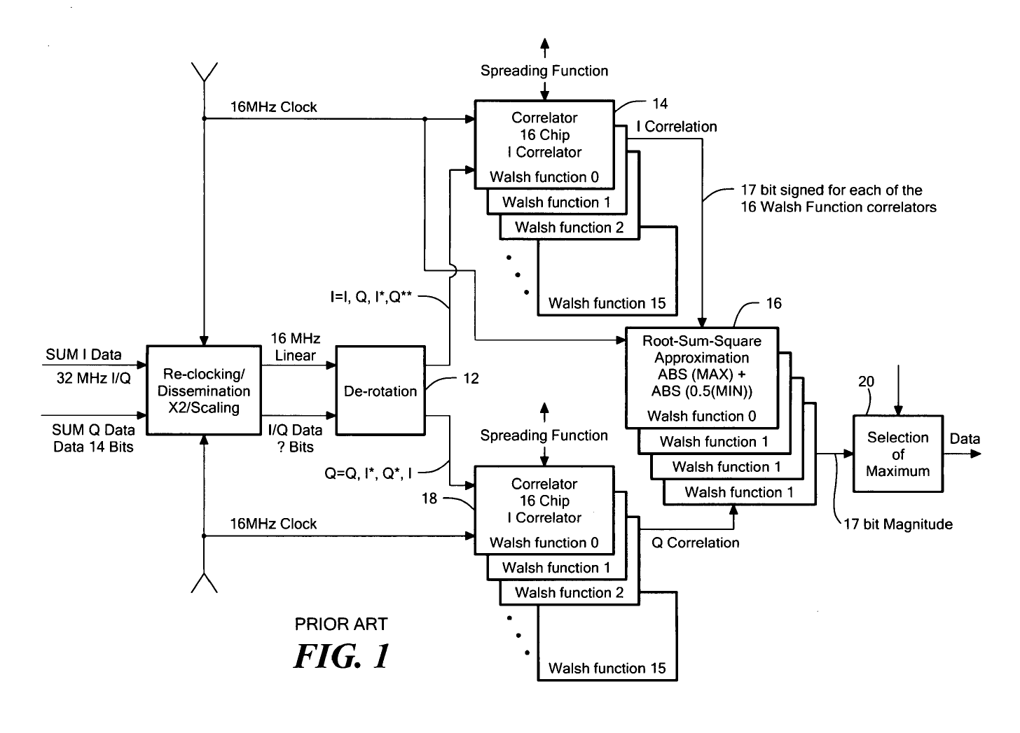

FIG. 2 shows further details of the prior art receiver of FIG. 1;

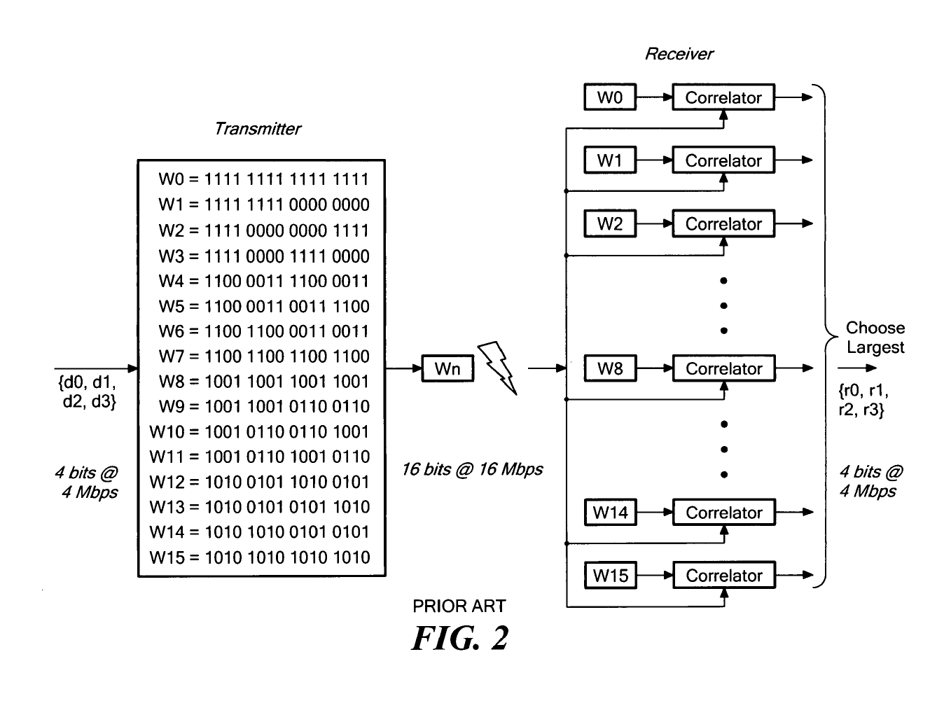

FIG. 3 is a schematic depiction of a receiver processor having Fast Walsh Transform processing in accordance with exemplary embodiments of the invention;

FIG. 4 is a schematic representation showing further details of the receiver processor of FIG. 3;

FIG. 5 is a signal flow graph of Fast Walsh Transform processing; and

FIG. 6 is a schematic depiction of an exemplary waveform to be processed;

FIG. 7 is a flow diagram of exemplary received signal processing in accordance with exemplary embodiments of the invention; and

FIG. 8 is a schematic representation of an exemplary circuit implementation.

### DETAILED DESCRIPTION

The present invention provides methods and apparatus for processing a received signal using a Fast Walsh Transform for correlation to enable a practical implementation with a linear receiver. In an exemplary embodiment, a waveform is encoded four bits at a time with a 16-chip Walsh sequence before transmission to realize processing gain through bandwidth expansion. In order to recover the four data bits, the receiver determines which of the 16 orthogonal Walsh sequences was the most likely signal transmitted.

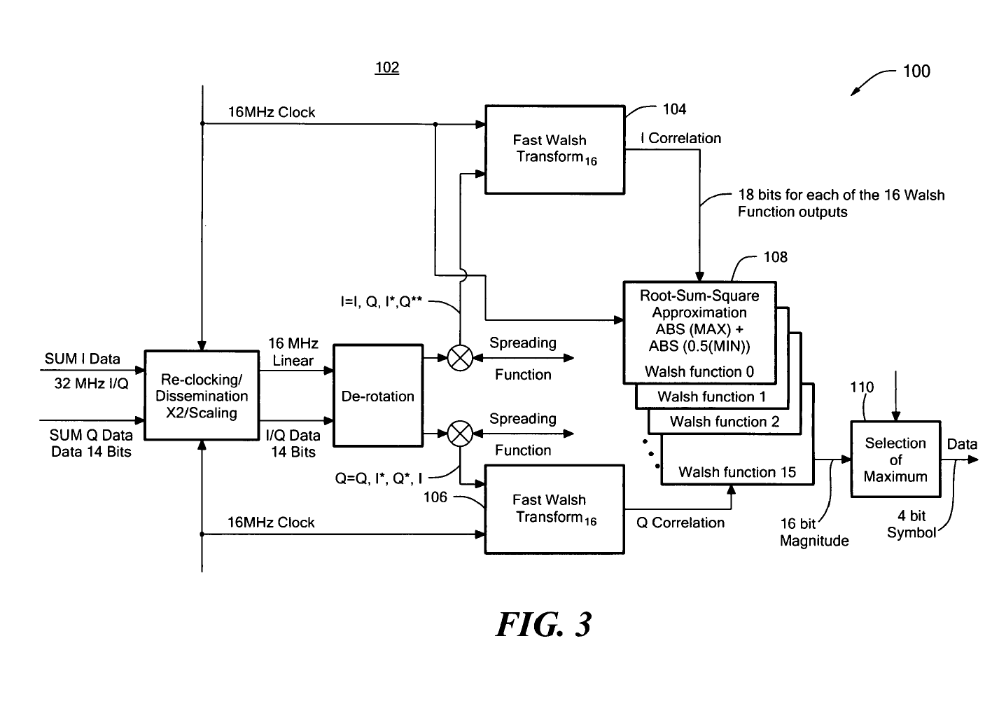

FIG. 3 shows a system 100 having a receiver 102 with Fast Walsh Transform correlation in accordance with exemplary embodiments of the invention. The input data are linear representations of the transmitted chip plus received noise, sampled once per chip epoch. The received chip estimate is provided to an I correlator module 104 and to a Q correlator module 106. The I correlator module 104 includes a Fast Walsh Transform module to generate the possible 16 Walsh sequences containing the 4 encoded information bits. In one embodiment, 18 bit signed data words are generated. A magnitude module, such as a Root-sum-square module 108, for example, is used to facilitate selection of the maximum of the generated words by a maximum selection module 110.

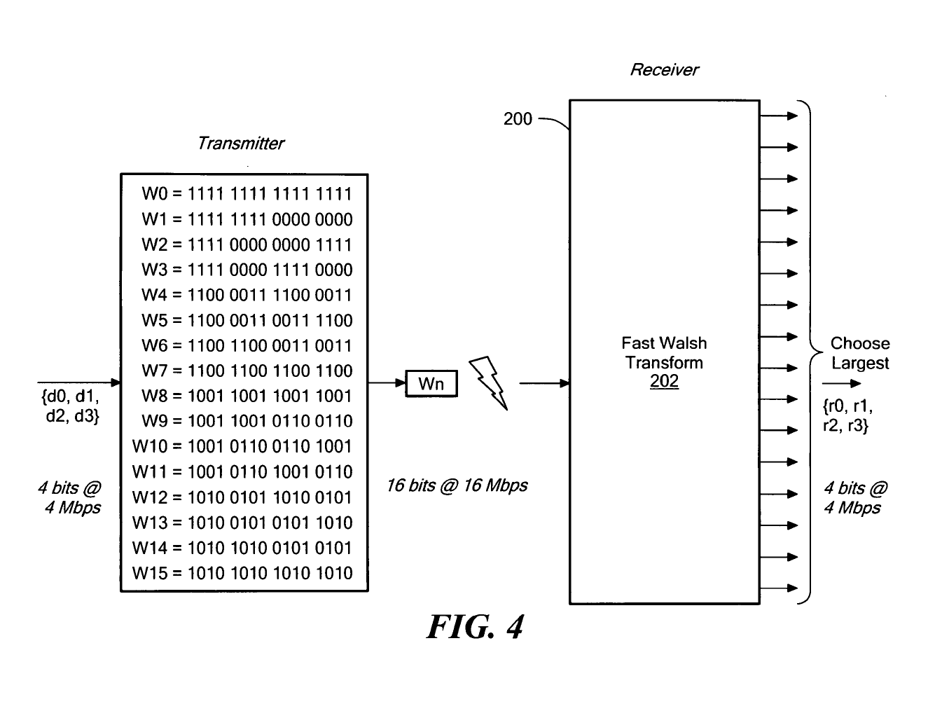

As shown in FIG. 4, at the transmitter 4 information bits are encoded using a 16-chip Walsh sequence so that 16 chip symbols are transmitted, such as over the air interface. It will be appreciated that the data can be transmitted using a wide variety of techniques in any medium. The receiver 200 receives the data and performs Fast Walsh Transform processing 202 to generate 16 Walsh sequences. The maximum of the sequences is selected from which the encoded 4 bits can be determined.

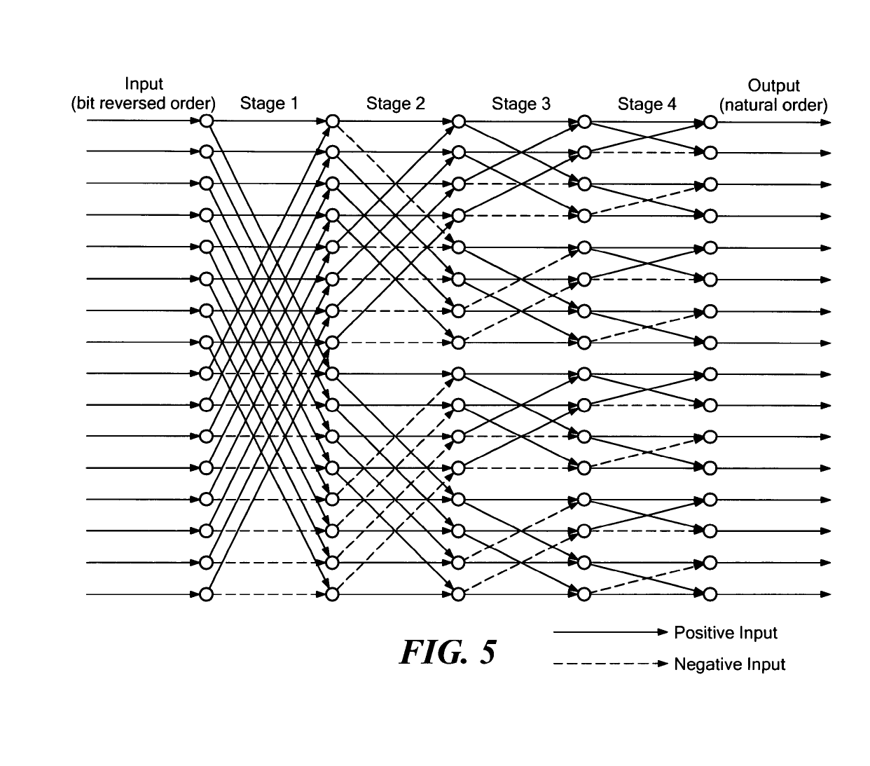

FIG. 5 shows an exemplary signal flow graph for a Fast Walsh Transform in accordance with an exemplary embodiment of the invention. The 16 input samples are processed in bit-reversed order at stage 1. Positive inputs are shown as dark lines and negative inputs are shown as dashed lines. The butterfly operations are additions or subtractions as multiplications are not needed. Stages 2-4 process the data as shown to provide the 16-bit output. U.S. Pat. No. 5,357,454 to Dent, which is incorporated herein by reference, shows an exemplary Fast Walsh Transform processor that may be useful in performing Fast Walsh Transform processing.

Fast Walsh Transform provides an efficient mechanism for simultaneously determining the cross correlation of a signal with a complete set of Walsh functions. Computation of a Fast Walsh Transform takes N log₂ N operations. In contrast, conventional direct correlation receiver processors require N² operations. For N=16, a Fast Walsh Transform requires about 64 operations and a direct correlator requires about 256 operations. Because the same operations need to be performed in both the in-phase and quadrature channel, the comparison is actually between 512 operations and 128 operations. This enables a practical linear receiver without trading off hardware resources for performance over an operating envelope.

The Fast Walsh Transform transforms to sequency, i.e., half the number of zero crossings in one cycle of the time base, which provides an estimate of the cross correlation with the Walsh basis functions.

It is understood that exemplary embodiments of the invention are applicable to any practical waveform in which efficient processing is desirable. Illustrative waveforms are described herein in order to facilitate an understanding of the invention and should not be construed to limit the scope of the invention.

The IFF Mode 5 waveforms described in DoD AIMS 03-1000A and STANAG 4193 use Walsh sequence encoding of data in the processing gain waveforms to realize a process gain through bandwidth expansion over uncoded signals. The level 1 and level 2 interrogations and replies use the processing gain waveforms. The waveforms comprise discrete packets of transmission, divided into a preamble section and a payload section. The preamble section has characteristics cryptographically determined that must be detected correctly in order to process the payload data.

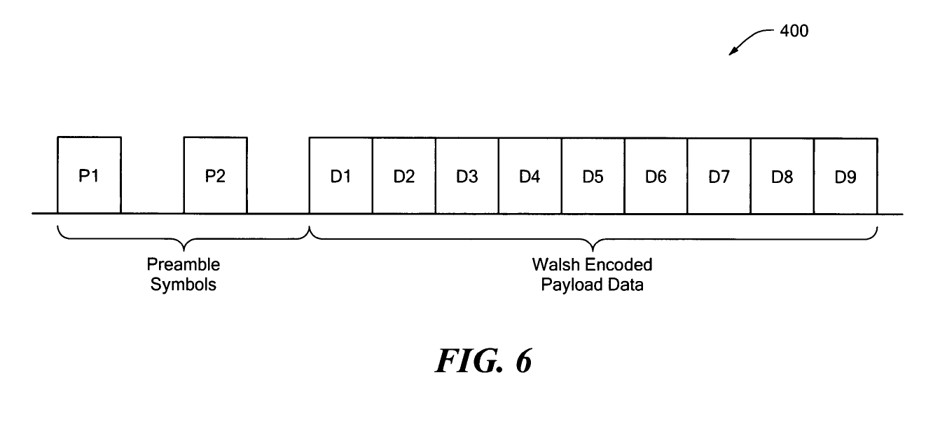

The payload section contains data symbols that are Walsh sequence encoded. For example, FIG. 6 shows an exemplary reply waveform 400 containing first and second fixed value preamble symbols P1, P2 and nine Walsh encoded data symbols D1-D9. Each data symbol Dn represents four bits of information encoded into a 16 chip Walsh sequence. Before transmission, each of the 16 bit symbols is protected by a cryptographically determined 16-chip cover sequence exclusive-ORed with the sequence. That same cover sequence is generated by a receiver function with the identical cryptographic state to unmask the 16-chip Walsh sequences. The received data is then cross correlated 16 chips at a time with the set of 16-chip Walsh sequences to determine the most likely four information bits that were sent.

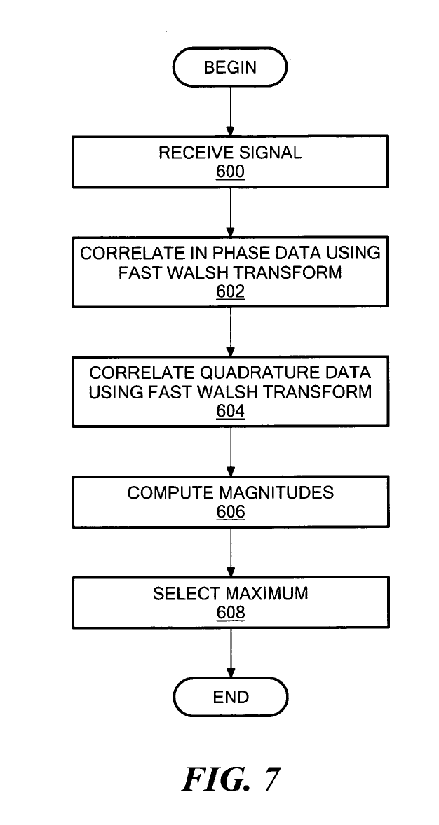

FIG. 7 shows an exemplary sequence of steps for providing processing of received signals using a Fast Walsh Transform. In step 600, a signal is received by a receiver processor. In step 602, Fast Walsh Transform correlator processing provides I correlation data, e.g., 18-bit signed data words. Q correlation data is correlated in step 604. In step 606, the magnitude of the correlation results is computed. The maximum value is selected in step 608 from which the originally encoded data can be decoded.

It is understood that the processing of data in accordance with exemplary embodiments of the invention can be implemented in a wide variety of architectures, configurations, and hardware/software partitions to meet the needs of a particular application. Exemplary implementations are provided in order to facilitate comprehension of exemplary embodiments and should not be considered to limit the scope of the invention in any way. In addition, it is understood that any practical number of data bits can be processed.

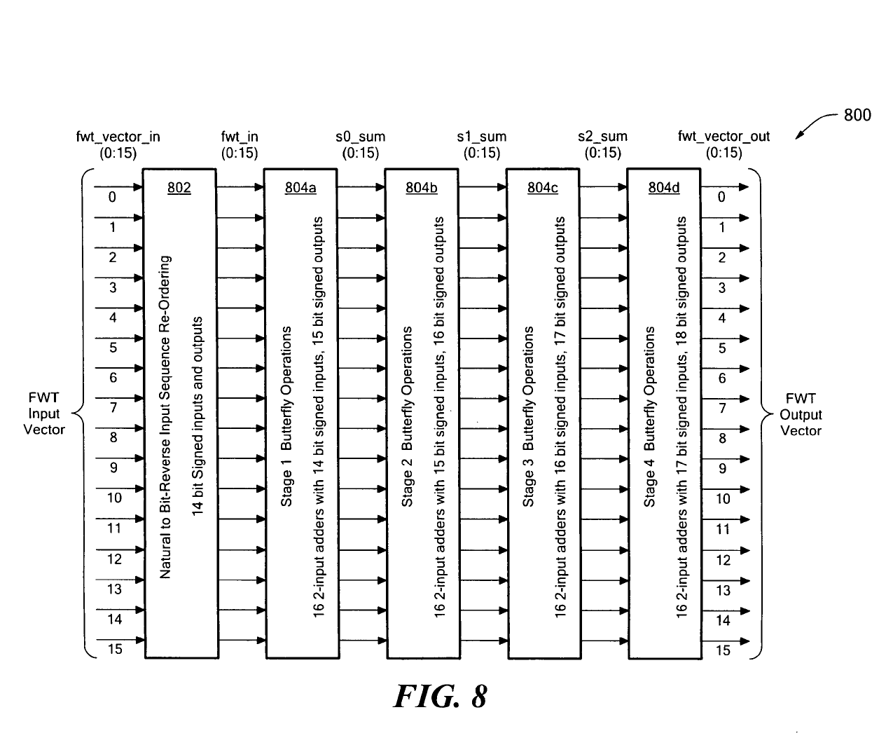

FIG. 8 shows an exemplary implementation 800 in an illustrative Field Programmable Gate Array (FPGA) device. The Fast Walsh Transform is realized as a set of data operations in the FPGA. In the illustrative embodiment, operations are grouped into five blocks: a data re-ordering block 802 and first, second, third, and fourth stages of butterfly operations 804a, b, c, d. In the first stage 802, a vector of 16 input samples of 14 bit signed data are re-ordered from natural order to a bit reversed address order as given in the exemplary arrangment below:

fwt_in(0)=fwt_vector_in(0);

fwt_in(1)=fwt_vector_in(8);

fwt_in(2)=fwt_vector_in(4);

fwt_in(3)=fwt_vector_in(12);

fwt_in(4)=fwt_vector_in(2);

fwt_in(5)=fwt_vector_in(10);

fwt_in(6)=fwt_vector_in(6);

fwt_in(7)=fwt_vector_in(14);

fwt_in(8)=fwt_vector_in(1);

fwt_in(9)=fwt_vector_in(9);

fwt_in(10)=fwt_vector_in(5);

fwt_in(11)=fwt_vector_in(13);

fwt_in(12)=fwt_vector_in(3);

fwt_in(13)=fwt_vector_in(11);

fwt_in(14)=fwt_vector_in(7);

fwt_in(15)=fwt_vector_in(15);

The stage 1 butterfly operations 804a take the 16 input samples of 14 bit signed data and output 16 data points of 15 bit signed data in the summing operations described below:

s0_sum(0)=fwt_in(0)+fwt_in(8);

s0_sum(1)=fwt_in(1)+fwt_in(9);

s0_sum(2)=fwt_in(2)+fwt_in(10);

s0_sum(3)=fwt_in(3)+fwt_in(11);

s0_sum(4)=fwt_in(4)+fwt_in(12);

s0_sum(5)=fwt_in(5)+fwt_in(13);

s0_sum(6)=fwt_in(6)+fwt_in(14);

s0_sum(7)=fwt_in(7)+fwt_in(15);

s0_sum(8)=−fwt_in(8)+fwt_in(0);

s0_sum(9)=−fwt_in(9)+fwt_in(1);

s0_sum(10)=−fwt_in(10)+fwt_in(2);

s0_sum(11)=−fwt_in(11)+fwt_in(3);

s0_sum(12)=−fwt_in(12)+fwt_in(4);

s0_sum(13)=−fwt_in(13)+fwt_in(5);

s0_sum(14)=−fwt_in(14)+fwt_in(6);

s0_sum(15)=−fwt_in(15)+fwt_in(7);

The stage 2 butterfly operations 804b take the 16 input samples of 15 bit signed data and output 16 data points of 16 bit signed data in the operations described below:

s1_sum(0)=s0_sum(0)+s0_sum(4);

s1_sum(1)=s0_sum(1)+s0_sum(5);

s1_sum(2)=s0_sum(2)+s0_sum(6);

s1_sum(3)=s0_sum(3)+s0_sum(7);

s1_sum(4)=−s0_sum(4)+s0_sum(0);

s1_sum(5)=−s0_sum(5)+s0_sum(1);

s1_sum(6)=−s0_sum(6)+s0_sum(2);

s1_sum(7)=−s0_sum(7)+s0_sum(3);

s1_sum(8)=s0_sum(8)+−s0_sum(12);

s1_sum(9)=s0_sum(9)+−s0_sum(13);

s1_sum(10)=s0_sum(10)+−s0_sum(14);

s1_sum(11)=s0_sum(11)+−s0_sum(15);

s1_sum(12)=s0_sum(12)+s0_sum(8);

s1_sum(13)=s0_sum(13)+s0_sum(9);

s1_sum(14)=s0_sum(14)+s0_sum(10);

s1_sum(15)=s0_sum(15)+s0_sum(11);

The stage 3 butterfly operations 804c take the 16 input samples of 16 bit signed data and output 16 data points of 17 bit signed data in the operations described below:

s2_sum(0)=s1_sum(0)+s1_sum(2);

s2_sum(1)=s1_sum(1)+s1_sum(3);

s2_sum(2)=−s1_sum(2)+s1_sum(0);

s2_sum(3)=−s1_sum(3)+s1_sum(1);

s2_sum(4)=s1_sum(4)+−s1_sum(6);

s2_sum(5)=s1_sum(5)+−s1_sum(7);

s2_sum(6)=s1_sum(6)+s1_sum(4);

s2_sum(7)=s1_sum(7)+s1_sum(5);

s2_sum(8)=s1_sum(8)+s1_sum(10);

s2_sum(9)=s1_sum(9)+s1_sum(11);

s2_sum(10)=−s1_sum(10)+s1_sum(8);

s2_sum(11)=−s1_sum(11)+s1_sum(9);

s2_sum(12)=s1_sum(12)+−s1_sum(14);

s2_sum(13)=s1_sum(13)+−s1_sum(15);

s2_sum(14)=s1_sum(14)+s1_sum(12);

s2_sum(15)=s1_sum(15)+s1_sum(13);

The stage 4 butterfly operations 804d take the 16 input samples of 17 bit signed data and output 16 data points of 18 bit signed data in the operations described below:

fwt_vector_out(0)=s2_sum(0)+s2_sum(1)

fwt_vector_out(1)=−s2_sum(1)+s2_sum(0)

fwt_vector_out(2)=s2_sum(2)+−s2_sum(3)

fwt_vector_out(3)=s2_sum(3)+s2_sum(2)

fwt_vector_out(4)=s2_sum(4)+s2_sum(5)

fwt_vector_out(5)=−s2_sum(5)+s2_sum(4)

fwt_vector_out(6)=s2_sum(6)+−s2_sum(7)

fwt_vector_out(7)=s2_sum(7)+s2_sum(6)

fwt_vector_out(8)=s2_sum(8)+s2_sum(9)

fwt_vector_out(9)=−s2_sum(9)+s2_sum(8)

fwt_vector_out(10)=s2_sum(10)+−s2_sum(11)

fwt_vector_out(11)=s2_sum(11)+s2_sum(10)

fwt_vector_out(12)=s2_sum(12)+s2_sum(13)

fwt_vector_out(13)=−s2_sum(13)+s2_sum(12)

fwt_vector_out(14)=s2_sum(14)+−s2_sum(15)

fwt_vector_out(15)=−s2_sum(15)+s2_sum(14)

Note that representation of the data grows by one bit at each of the stages of butterfly operations to account for potential overflow in the addition operations. The butterfly stages process the data in a pipeline, such that at each clock transition the data results are propagated from one stage to the next. Each stage uses 16 adders, so there are a total of 64 adders used across all the stages.

In an exemplary embodiment, the 16 sample data vectors propagate from butterfly stage to butterfly stage in a pipeline at a clock rate equal to the data sampling rate divided by 16. Because there are four butterfly stages, there is an intrinsic pipeline delay of four 16 sample data epochs. New data enters the input to the pipeline each epoch, so that is a continuous stream of output data output every 16 sample time epoch.

Having described exemplary embodiments of the invention, it will now become apparent to one of ordinary skill in the art that other embodiments incorporating their concepts may also be used. The embodiments contained herein should not be limited to disclosed embodiments but rather should be limited only by the spirit and scope of the appended claims. All publications and references cited herein are expressly incorporated herein by reference in their entirety.

What is claimed is:

1. A method, comprising:
receiving a complex valued Walsh encoded signal in the in-phase and quadrature channels of a linear receiver processor;
performing Fast Walsh Transform processing to generate estimates of a cross correlation of the received Walsh encoded signal with Walsh sequences separately in the in-phase and quadrature channels;
combining the estimates of the in-phase and quadrature channel data using a magnitude approximation;
selecting a first one of the data words from the combined estimates having a largest magnitude;
decoding the encoded signal using the selected first one of the data words; and
outputting the decoded signal.

2. The method according to claim 1, further including using linear representations of the transmitted chip plus received noise as the input to the Walsh Transform processing.

3. The method according to claim 1, further including using sixteen Walsh sequences for the Fast Walsh Transform processing.

4. The method according to claim 1, further including performing the Fast Walsh Transform processing in a pipelined configuration.

5. The method according to claim 4, further including accepting vectors of 16 input data samples and providing related results four epochs of 16 sample epochs later.

6. The method according to claim 1, further including acceptance of new input data samples into the Fast Walsh Transform processing pipeline every sixteen sample epochs.

7. The method according to claim 1, wherein the magnitude approximation includes a root-sum-square approximation.

8. The method according to claim 1, wherein the waveform includes at least one preamble symbols and Walsh encoded data symbols.

9. The method according to claim 1, wherein the received signal is encoded four bits at a time with a 16-bit Walsh sequence.

10. A system, comprising:
a receiver to receive a Walsh encoded input signal;
an in-phase Fast Walsh Transform module to generate in-phase data words by performing Fast Walsh Transform processing for generating estimates of cross correlation of the received Walsh encoded input signal with Walsh sequences;
a quadrature Fast Walsh Transform module to generate quadrature data words by performing Fast Walsh Transform processing for generating estimates of cross correlation of the received Walsh encoded input signal with Walsh sequences;
a magnitude module to combine the respective in-phase data words from the in-phase module and the quadrature data words from the quadrature module for providing magnitude information for the data words; and
a selection module to select a first one of the combined in-phase and quadrature data words having a greatest magnitude.

11. The system according to claim 10, wherein the magnitude module includes a root-sum square module.

12. The system according to claim 10, wherein the input signal is encoded four bits at a time with a 16-bit Walsh sequence.

13. The system according to claim 12, wherein the Fast Walsh Transform processing is performed in a data-re-ordering stage and four stages of butterfly operations.
